(19) United States
(12) Patent Application Publication
(10) Pub. No.: US 2021/0397581 A1
(43) Pub. Date: Dec. 23, 2021

(54) SPARSE FILE SYSTEM IMPLEMENTED WITH MULTIPLE CLOUD SERVICES

(71) Applicant: SCALITY, S.A., Paris (FR)

(72) Inventors: Giorgio REGNI, Albany, CA (US); Vianney RANCUREL, Sausalito, CA (US); Nicolas TRANGEZ, Antwerpen (BE)

(21) Appl. No.: 17/350,998

(22) Filed: Jun. 17, 2021

Related U.S. Application Data
(60) Provisional application No. 63/041,895, filed on Jun. 20, 2020.

(51) Int. Cl. G06F 16/13; G06F 16/174; G06F 16/172; G06F 16/182; G06F 16/11; G06F 16/14

(52) U.S. Cl. CPC G06F 16/13; G06F 16/1744; G06F 16/14; G06F 16/1844; G06F 16/128; G06F 16/172

(57) ABSTRACT

An apparatus to implement a sparse file system has been described. The sparse file system includes an execution engine cloud service to receive user requests to the sparse file system and implement a cache for the sparse file system and cache coherence protocol logic for the cache. The sparse file system also includes a database cloud service to store meta data for any of files, stripes and stripe sections of the sparse file system and implement a search function that identifies any of files, stripes and stripe sections of the sparse file system that meet certain meta data search criteria. The sparse file system also includes an object storage cloud service that assigns individual object IDs to individual stripes within the sparse file system.

### RELATED CASE

This application claims the benefit of U.S. Provisional Application No. 63/041,895, entitled, “SPARSE FILE SYSTEM IMPLEMENTED WITH MULTIPLE CLOUD SERVICES”, filed Jun. 20, 2020, which is incorporated by reference in its entirety.

### FIELD OF INVENTION

The field of invention pertains generally to the computing sciences, and, more specifically, to a sparse file system implemented with multiple cloud services.

### BACKGROUND

With the emergence of big data, low latency access to large volumes of information is becoming an increasingly important parameter of the performance and/or capability of an application that processes or otherwise uses large volumes of information. Moreover, cloud services have come into the mainstream that allow networked access to high performance computing component resources such as CPU and main memory resources (execute engine), database resources and/or storage resources.

### FIGURES

A better understanding of the present invention can be obtained from the following detailed description in conjunction with the following drawings, in which:

FIG. 1 shows a sparse file (prior art);

FIG. 2 show an architecture for implementing a sparse file system;

FIG. 3 shows a method;

FIG. 4 shows a computing system.

### DETAILED DESCRIPTION

A high performance sparse file (or other kind of thin provisioned) storage system is described herein.

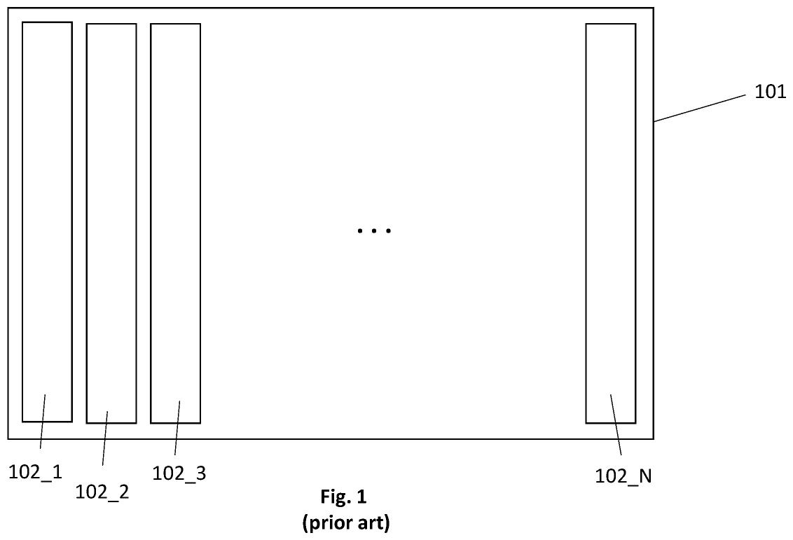

Referring to FIG. 1, as is known in the art, a sparse file can be a single file 101 whose storage resources are broken down into smaller units of storage, referred to as “stripes” 102_1 through 102_N. Individual stripes 102_1, 102_2, . . . 102_N within the file 101 are uniquely identified by an offset. Sparse files have been used to make more efficient use of physical storage resources. For example, stripes that are actually written to contain their respective data in physical storage, while, stripes that have not been written to do not consume any physical storage resources. As such, the size of the overall file 101 is reduced as compared to a traditional file (in which physical storage resources sufficient to the entire file had to be allocated or otherwise reserved).

Thin provisioning generally refers to storage systems whose file structures are designed to consume less storage space than what their users believe has been allocated to them by breaking down units of storage (e.g., files) into smaller pieces (e.g., stripes) that can be uniquely accessed, written to and read from. If a smaller piece is not actually written to, it consumes little/no physical storage space thereby conserving physical storage resources.

For the sake of illustrative convenience, the following discussion will pertain mainly to sparse file system implementations. However, the reader should understand the discussion herein is applicable at least to thin provisioned systems other than sparse file systems.

In the case of high performance (e.g., data center) environments, certain sparse files, their individual stripes, or even certain sections of a particular stripe, may be more frequently accessed than other sparse files, stripes or sections of a same stripe. As such, caching is a desirable feature of a high performance sparse file system.

Moreover, multiple users (e.g., client applications) may concurrently desire to access the same sparse file, stripe and/or stripe section. As such, locking or other cache coherency function is also a desirable feature of a high performance sparse file system.

Further still, certain users may desire advanced storage system functions that run “on top of” the file system such as mirroring (which duplicates data, e.g., for reliability reasons (protects against data loss) or performance reasons (e.g., in the case of a read-only data)) and snapshots (which preserves a certain state of the storage system or smaller component thereof).

Even further, it is often desirable that certain meta data be tracked for the files, stripes and/or sections of a stripe (hereinafter, “sections”) within a sparse file system. For example, some indication of the file's/stripe's/section's content (e.g., its textual content, its image content, etc.), size, time of last access, time elapsed since last access, time of last write, whether the file/stripe is read-only, etc. is tracked. Here, e.g., each time a file/stripe/section is accessed or updated (written to), its meta data is updated. Moreover, certain functions can execute on top of the meta data such as a search function (e.g., that can find files/stripes/sections whose meta data meets a certain search criteria).

Finally, different types of cloud services are readily available to those who implement or use high performance storage systems (such as data center administrators). A cloud service provider typically provides some kind of computing component (e.g., CPU processing power, storage, etc.) that is accessible through a network such as the Internet. Here, the different types of cloud services that are commonly available can exhibit different kinds of performance and/or cost tradeoffs with respect to their role/usage within a sparse file storage system.

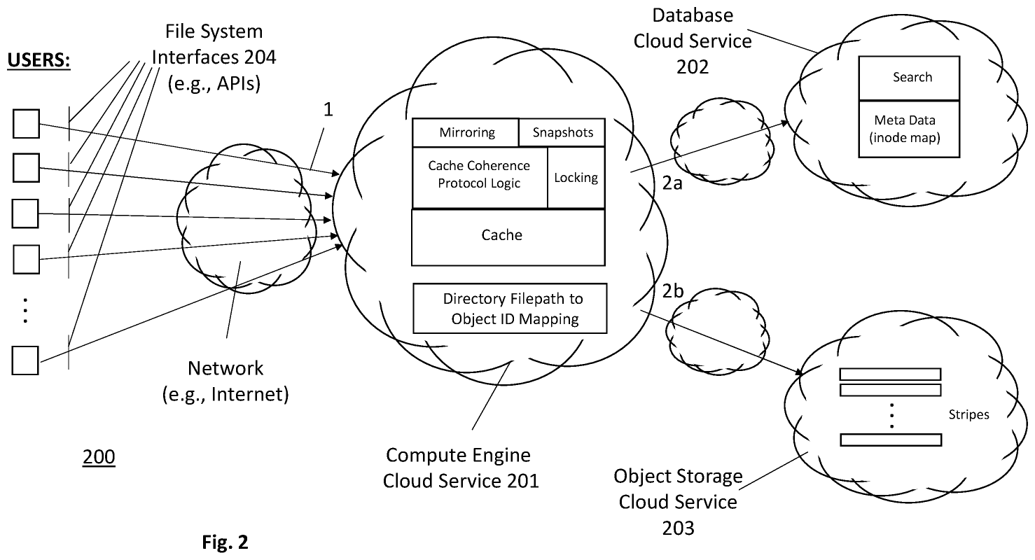

FIG. 2 shows a new sparse file storage system architecture 200 that uses different kinds of cloud services 201, 202, 203 to strike an optimized balance between the associated tradeoffs of the cloud services 201, 202, 203 and the role they play in the overall sparse file storage system 200.

In the particular example shown in FIG. 2, the three different kinds of cloud services 201, 202, 203 include: 1) an “execution” or “compute engine” cloud service 201 that is used as a front end to receive user requests and execute the logic of the one or more aforementioned higher level functions such as caching, cache coherency, locking, snapshots, mirroring, etc.; 2) a database cloud service 202 that is used to keep meta data for individual sparse files and/or their respective stripes and/or individual sections of sparse files; and, 3) a storage cloud service 203 that stores individual stripes as units of stored data (stripes are uniquely call-able in cloud storage service 203).

Here, the first cloud service 201 is implemented with a scalable compute engine cloud service. As is known in the art, a compute engine cloud service essentially dispatches or otherwise allocates central processing unit (CPU) compute power to users of the cloud service 201. Examples include Amazon Elastic Compute Cloud (Amazon EC2), the Google Cloud Compute Engine and the compute services of Microsoft's Azure web services platform.

Some or all of these services may dispatch one or more virtual machines or containers to their respective users where, e.g., each virtual machine/container is assigned to a particular user thread, request, function call, etc. Here, the allocation of a virtual machine or container typically corresponds to the allocation of some amount of underlying CPU resource (e.g., software thread, hardware thread) to the user. The amount of allocated CPU resource can be maintained quasi-permanently for a particular user or can be dynamically adjusted up or down based on user need or overall demand being placed on the service 201.

Regardless, because of the ability of the allocated CPU resources to quickly execute complex software logic, a compute engine service 201 is the better form of cloud service for the aforementioned higher level services (e.g., caching, cache coherency protocols, locking, mirroring, snapshots) because such functions typically require the execution of high performance, sophisticated software logic.

For instance, in the case of caching, CPU resources and their associated high performance (e.g. main) memory keep the more frequently accessed sparse files, stripes and/or stripe sections in memory. As such, user request reads and writes directed to any of these items, when in memory, can be accomplished much faster than if they were to be performed directly on the stored items in deeper data storage 203. Moreover, because the compute engine service 201 is scalable (e.g., can increase the number of VMs in response to increased user requests), a greater degree of parallelism is achievable. For instance, in the case of many non-competing requests (e.g., a large number of requests that do not target the same sparse file/stripe/section), all of the non-competing requests can be serviced concurrently or otherwise in parallel (approximately the same time).

In various embodiments, the compute engine service 201 is able to service requests received from users of the storage system (e.g., client application software programs, client computers, etc.) that have been provided with interfaces 204 to one or more specific types of file systems (e.g., NFSv3, NFSv4, SMB2, SMB3, FUSE, CDMI, etc.). Each interface is implemented, e.g., as an application program interface (API) that provides a user with a set of invokable commands and corresponding syntax, and their returns (collectively referred to as “protocols”), that are defined for the particular type of file system being presented. In one embodiment, instances of interfaces execute on the user side and the compute engine service 201 receives user requests from these interfaces.

In various embodiments, the second cloud service 202 is implemented as a database cloud service such as any of Amazon Aurora, Amazon DynamoDB and Amazon RDS offered by Amazon; Cloud SQL offered by Google; Azure SQL Database and/or Azure Cosmos DB offered by Microsoft. Other possible cloud database services include MongoDB, FoundationDB and CouchDB. A database includes a tree-like structures (e.g., a B− tree, a B+ tree, or an LSM tree) at its front end which allows sought for items to be accessed very quickly (a specified item can be accessed after only a few nodal hops through the tree). In essence, each node of the tree can spawn many branches to a large set of next lower children nodes. “Leaf nodes” exist at the lowest nodal layer and contain the data being stored by the database.

In various embodiments, as described above, the database cloud service 202 is used to store meta data for any/all of individual sparse files/stripes/sections (the meta data for the file/stripes/sections are stored in leaf nodes which can be implemented, e.g., as pages or documents (eXtensive Markup Language (XML) pages, or JSON)). Here, again, because the tree structure at the head of the database is able to quickly access information, low-latency access to the meta data for any file/stripe/section can be achieved.

Further still, databases lend themselves very well to search functions. For example, if there are N different items of meta data being tracked for each file/stripe/section, there can exist one database to store the set of N meta data items for each file/stripe/section, and one dedicated database whose tree structure sorts the leaf nodes based on the value of a particular meta data value (the leaf nodes contain the identifiers of files/stripes/sections and are sorted/organized based on a particular meta data value).

Thus there can be N+1 databases, one database whose leaf nodes keeps all meta data for each file/stripe/section, and one database for each of the N different items of meta data. With such an arrangement, any particular meta data item can be searched over (i.e., files/stripes/sections having a particular value for a particular item of meta data are identified) by applying the search argument (the particular meta data value) to the database whose leaf nodes are sorted based on values for that meta data item.

The third cloud service is a cloud storage service 203. Here, unlike the compute engine cloud service 201 (which is optimized for logic execution) and the database cloud service 202 (which is optimized for fast access to meta data and searching), the third cloud service 203 is optimized for storage. Here, the optimization toward storage can be exemplified by any of extremely large data storage capability (e.g., petabytes or more), data reliability (guarantees that data will never be lost) and cost (e.g., lowest cost per stored data unit as compared to other cloud services).

In various embodiments, the cloud storage service 203 is implemented as cloud object storage service. Examples include Amazon Simple Storage Service (Amazon S3), Google Cloud Storage and Azure Blob Storage from Microsoft (all of which are cloud object storage systems). As is known in the art, in the case of object storage systems, units of stored information (“objects”) are identified with unique identifiers (“object IDs”).

Thus, whereas a traditional file system identifies a targeted stored item with a path that flows through a directory hierarchy (“filepath”) to the item, by contrast, in the case of object storage systems, targeted stored items are identified with a unique ID for the object. Here, any of each sparse file, each stripe within a sparse file and/or each section of a stripe can be implemented with an object or cluster of objects that are reachable with a single object ID (and thus become a unit of storage).

With respect to the processing flow of a nominal user read or write request 1 without caching, according to one approach, the compute engine cloud service 201 performs the mapping of the request's specified filepath to the object ID for the file/stripe/section in the object cloud service 203 that is the target of the request. After the mapping, the object ID can be applied directly 2a, 2b to the database cloud service 202 to update the meta data associated with the access (here, the database uses the object ID used by the object storage service 203 as keys) and the object storage service 203 to physically fetch the file/stripe/section in the case of a read, or, physically update the file/stripe/section with new information in the case of a write.

In the case of caching, the file/stripe/section that is targeted by the received request 1 is initially looked for in the cache kept by the compute engine cloud storage service 201. If the targeted item is found in the cache (cache hit), the meta data is updated 2a in the database cloud service 202, but the access 2b to the cloud storage service 203 is not performed because the read or write request can be serviced with the version of the file/stripe/section that was found in the cache in the compute engine cloud service 201.

Depending on implementation, the cache may be a write-through cache or a write-back cache. In the case of a write-through cache, each time a version of a file/stripe/section in the cache is written to, the same update is (e.g., immediately) written 2b to the object cloud storage service s203 so that the version in the object cloud storage service 203 is constantly trying to keep up (be consistent) with the latest version in the cache. In the case of a write-back cache, the version in cache is allowed to be written to multiple times before any attempt is made to update 2b its sibling in the object cloud storage service 203. Here, updates back to the object cloud storage system 203 may be performed, e.g., periodically, after a number of writes have been performed to the version in cache, after expiration of a timer since the last write to the version in cache, when the version in cache is being evicted from the cache, etc.

Here, the capacity of the cache is less than the capacity of the storage service that has been reserved for the file system. As such, the entry of more frequently and/or most recently accessed files/stripes/sections into the cause will cause the eviction of less frequently and/or least recently accessed files/stripes/sections. If any such evicted files/stripes/sections are dirty (received a write/update that is not reflected in the sibling version in storage 203), they are written into the storage service 203 so that the storage service 203 maintains the most recent version of the item.

Note that each of the cloud services 201, 202, 203 are themselves separated by networks. Here, if a different service provider is used for each of the three services (e.g., Amazon is used for one, Google Cloud is used for another and Azure is used for the third), these networks can correspond to the Internet. If a same service provider is used for any two of the services, the network between the two services can be an internal network of the service provider, the Internet, or some combination thereof. Note that some or all of the cloud services 201, 202, 203 can be private (a cloud service need not be commercially offered) and/or are accessible through a private network rather than a public network.

In an embodiment, if mirroring is performed for any particular file, stripe or section, whenever any such section is written to with a write request and there is a cache hit, the compute service engine duplicates the write to each copy of the item in the storage service 203. If there is a cache miss, the compute engine service can duplicate the writes or the object storage service 203 can convert the single write into multiple writes within the storage service 203.

With respect to snapshots of any of the entire sparse file system, a specific set of one or more files/stripes/sections, a duplicate copy is made of each affected item and made immutable (can not be written to). So doing preserves the state of the affected items as of the taking of the snapshot.

Here, whether as a result of snapshots or otherwise, different versions of a same folder/stripe/section can exist in the storage cloud service 203. In an embodiment, the different versions are kept track of in the file's/stripe's/section's meta data. That is, for instance, the meta lists the different object IDs for each of the different versions and any other versioning related information (which snapshot each different version corresponds to).

Such versioning information can also identify which particular object is the main object (the one that represents the current state of the file/stripe/section). In systems that manage versions this way, note that access requests for a particular folder/file/section in the storage cloud 203 should perform a lookup in the folder's/stripe's/section's meta data information in the database cloud service 202 (accesses to the storage cloud 203 are preceded by accesses to the database cloud 202).

In one category of embodiments, the database cloud service 202 is a distributed consistent database implemented within an object store as described in U.S. patent application Ser. No. 14/198,486 filed on Mar. 5, 2014, published on Sep. 10, 2015 with Publication No. 2015/0254272 and assigned to Scality, Inc. of Paris, France and San Francisco, Calif. U.S.A. which is hereby incorporated by reference.

As described in the above identified patent application, units of storage (such as stripes in a sparse file) are implemented as one or more objects stored in an object storage system. Each unit of storage is reached through a hierarchy of pages whose content serves as the B+ tree of the database. With respect to the system of FIG. 2 of the instant application, the hierarchy of pages corresponds to the database cloud service 202 and the object storage system corresponds to the object cloud service 203.

Note that in any/all of the sparse file implementations described above, stripes within a same sparse file can all be of a same maximum size, or, can have different maximum sizes.

In various implementations, an “inode” is the unique identifier for a file in a sparse file system, and, a “main chunk” is a unit of information that contains meta-data information about an inode (a main chunk is a unit of meta data information). Here, a main chunk's meta-data information includes a “blob” of meta data (e.g., owner, group, access times, size, etc) and versioning information for the main chunk's file (e.g., if is supposed to reflect any change on the file: if it has changed, it is because its meta data has changed or its data has changed).

In various implementations, there is a hierarchy of meta data associated with a sparse file. For example, at the top or root of the hierarchy is where meta-data is kept for an entire sparse file. At a next lower level in the hierarchy are individual units of meta data that are kept for individual stripes. At a lowest level in the hierarchy are individual units of meta data that are kept for individual sections of a particular stripe. The meta-data itself is kept on pages that are organized according to the hierarchy (the meta data for a sparse file is implemented as a hierarchy of pages).

As such, in an embodiment, the main chunk for a particular inode (sparse file) includes: 1) a pointer to the root page of the meta data hierarchy for the sparse file; and, 2) a shadow paging table: to ensure atomic changes on a group of meta-date pages within the hierarchy. Here, in order to make changes to the meta-data, a transactional process is ensued. First, one or more new pages of meta data to be inserted into the hierarchy are created. Then the shadow paging table is updated in the main chunk (the shadow paging table includes references to the new pages or otherwise causes the new pages to be referred to in the hierarchy). Then the old pages are deleted. If there is an error during the transaction, the transaction can be rolled backed before the shadow paging table is updated.

In an embodiment in which the database cloud service 202 and the object storage service 203 are implemented as a distributed consistent store as described in the aforementioned published patent application, both main chunk meta-data information and the actual informational content of the sparse file can be stored in the same chunk on the object storage ring described therein (accessible by the inode key through the RING DHT).

Furthermore, in various embodiments implemented with a distributed consistent database, the main chunk content is the only “chunk” which is mutable. Here, there is an extra precaution when writing to this chunk (e.g., a quorum must be reached in the case of an extremely large scale database where access points to the meta-data is widely distributed) to ensure its consistency (and finally by bumping its version).

In various embodiments, the inode map is sharded on different storage endpoints within the database service 202. The directory entry collection can also be sharded on different database endpoints, but all entries of a given folder shall be on the same database endpoint.

In various embodiments, units of storage in the storage service 203 (e.g., files/stripes/sections) are accessible from the “head” software that executes on any VM or container that is instantiated in the compute engine 201 for the sparse file system. According to one configuration (“performance point A”), some of the units of storage are pooled (stored) together (called a “pool”) to optimize performance. A pool allows the spread of load on multiple units of data storage. According to another configuration (“performance point B”), a particular head within the compute engine service 201 has a particular affinity on a pool. For example, new files preferably are written to this pool by the head having the affinity for the pool. But at any time if a file accessed by the head has been created into another pool, its location can be checked, then it can be cached and accessed. Here, performance point A allows for maximum throughput while performance point B allows for linear scalability without theoretically any limitation beside the HW.

Additionally, NVMe flash storage devices are larger and cheaper than memory RAM. A head within the compute engine service can benefit from using NVMe flash storage devices to implement the cache. According to one embodiment, a stripe cache implemented with one or more NVMe flash storage devices stores the cached blocks (sub-part of chunks).

According to various embodiments, a head contains a built-in mechanism to coordinate with different heads for a same sparse file system when they operate on the same file and/or folders.

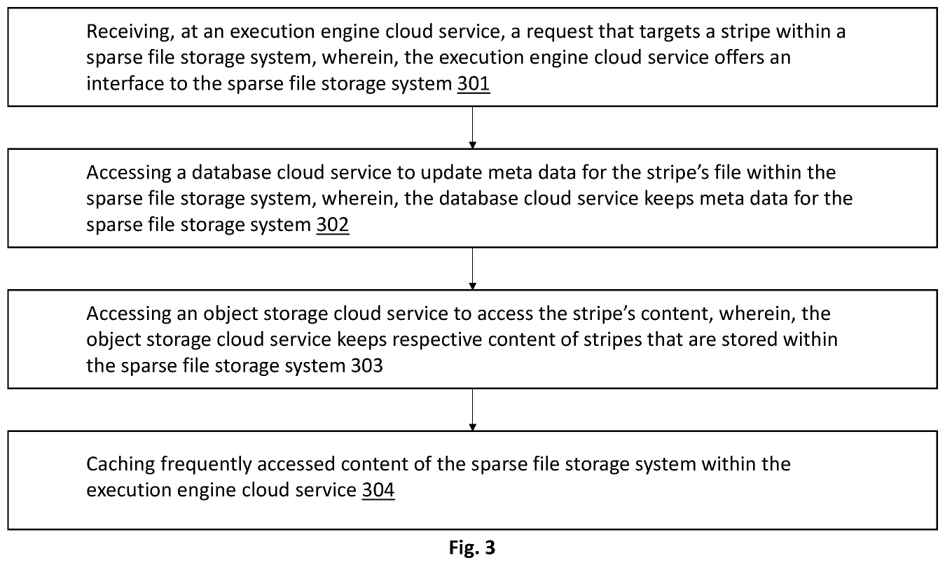

FIG. 3 illustrates a method described above. As observed in FIG. 3, the method includes receiving, at an execution engine cloud service, a request that targets a stripe within a sparse file storage system, wherein, the execution engine cloud service offers an interface to the sparse file storage system 301. The method also includes accessing a database cloud service to update meta data for the stripe's file within the sparse file storage system, wherein, the database cloud service keeps meta data for the sparse file storage system 302. The method also includes accessing an object storage cloud service to access the stripe's content, wherein, the object storage cloud service keeps respective content of stripes that are stored within the sparse file storage system 303. The method also includes caching frequently accessed content of the sparse file storage system within the execution engine cloud service 304.

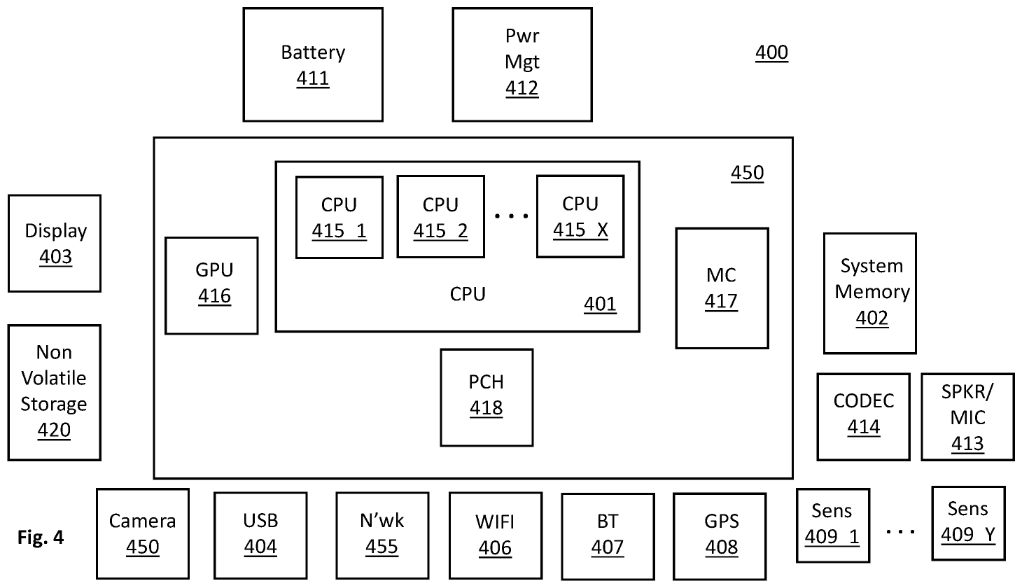

FIG. 4 provides an exemplary depiction of a computing system 400. Any of the aforementioned cloud services can be constructed, e.g., from networked clusters of computers having at least some of the components described below and/or networked clusters of such components.

As observed in FIG. 4, the basic computing system 400 may include a central processing unit (CPU) 401 (which may include, e.g., a plurality of general purpose processing cores 415_1 through 415_X) and a main memory controller 417 disposed on a multi-core processor or applications processor, main memory 402 (also referred to as “system memory”), a display 403 (e.g., touchscreen, flat-panel), a local wired point-to-point link (e.g., universal serial bus (USB)) interface 404, a peripheral control hub (PCH) 418; various network I/O functions 405 (such as an Ethernet interface and/or cellular modem subsystem), a wireless local area network (e.g., WiFi) interface 406, a wireless point-to-point link (e.g., Bluetooth) interface 407 and a Global Positioning System interface 408, various sensors 409_1 through 409_Y, one or more cameras 410, a battery 411, a power management control unit 412, a speaker and microphone 413 and an audio coder/decoder 414.

An applications processor or multi-core processor 450 may include one or more general purpose processing cores 415 within its CPU 401, one or more graphical processing units 416, a main memory controller 417 and a peripheral control hub (PCH) 418 (also referred to as I/O controller and the like). The general purpose processing cores 415 typically execute the operating system and application software of the computing system. The graphics processing unit 416 typically executes graphics intensive functions to, e.g., generate graphics information that is presented on the display 403. The main memory controller 417 interfaces with the main memory 402 to write/read data to/from main memory 402. The power management control unit 412 generally controls the power consumption of the system 400. The peripheral control hub 418 manages communications between the computer's processors and memory and the I/O (peripheral) devices.

Each of the touchscreen display 403, the communication interfaces 404-407, the GPS interface 408, the sensors 409, the camera(s) 410, and the speaker/microphone codec 413, 414 all can be viewed as various forms of I/O (input and/or output) relative to the overall computing system including, where appropriate, an integrated peripheral device as well (e.g., the one or more cameras 410). Depending on implementation, various ones of these I/O components may be integrated on the applications processor/multi-core processor 450 or may be located off the die or outside the package of the applications processor/multi-core processor 450. The computing system also includes non-volatile mass storage 420 which may be the mass storage component of the system which may be composed of one or more non-volatile mass storage devices (e.g. hard disk drive, solid state drive, etc.). The non-volatile mass storage 420 may be implemented with any of solid state drives (SSDs), hard disk drive (HDDs), etc.

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a sparse file system, comprising:
a) an execution engine cloud service to:
i) receive user requests to the sparse file system;
ii) implement a cache for the sparse file system and cache coherence protocol logic for the cache;
b) a database cloud service to:
i) store meta data for any of files, stripes and stripe sections of the sparse file system;
ii) implement a search function that identifies any of files, stripes and stripe sections of the sparse file system that meet certain meta data search criteria;
c) an object storage cloud service that assigns individual object IDs to individual stripes within the sparse file system.

2. The sparse file system of claim 1 wherein the execute engine cloud service is further to process the requests by:
i) access the database cloud service to update respective items of the meta data for respective ones of the files, stripes and/or stripe sections that are targeted by the requests;
ii) access the object storage cloud service to access respective content of respective ones of the stripes that are targeted by the requests.

3. The sparse file system of claim 2 wherein the execute cloud service is to map filepaths specified in the requests into Object IDs that are to be applied to the object storage cloud service.

4. The sparse file system of claim 2 wherein the execute cloud service is capable of offering a number of different storage system interfaces to users of the sparse file system.

5. The sparse file system of claim 1 wherein the execute cloud service is to mirror certain ones of the individual stripes within the sparse file system.

6. The sparse file system of claim 1 wherein the execute cloud service is to lock certain ones of the individual stripes within the sparse file system.

7. The sparse file system of claim 1 wherein the execute cloud service is to take snapshots of certain ones of the individual stripes within the sparse file system.

8. The sparse file system of claim 1 wherein each of the execution engine cloud service, the database cloud service and the object storage cloud service are accessible through the Internet.

9. The sparse file system of claim 1 wherein each of the execution engine cloud service, the database cloud service and the object storage cloud service are separated by the Internet.

10. A method, comprising:
receiving, at an execution engine cloud service, a request that targets a stripe within a sparse file storage system, wherein, the execution engine cloud service offers an interface to the sparse file storage system;
accessing a database cloud service to update meta data for the stripe's file within the sparse file storage system, wherein, the database cloud service keeps meta data for the sparse file storage system;
accessing an object storage cloud service to access the stripe's content, wherein, the object storage cloud service keeps respective content of stripes that are stored within the sparse file storage system; and,
caching frequently accessed content of the sparse file storage system within the execution engine cloud service.

11. The method of claim 10 wherein:
the request is sent to the execution engine cloud service through the Internet, the accessing of the database cloud service is performed by the execution engine cloud service sending a second request to the database cloud service through the Internet, and, the accessing of the object storage cloud service is performed by the execution engine cloud service sending a third request to the object storage cloud service through the Internet.

12. The method of claim 10 further comprising the execution engine cloud service mapping a filepath specified in the request to an object ID for the stripe that uniquely identifies the stripe's content within the object storage cloud service.

13. The method of claim 10 further comprising offering a number of different storage system interfaces from the execution engine cloud service.

14. The method of claim 10 further comprising the execute cloud service mirroring certain ones of the stripes within the sparse file storage system.

15. The method of claim 10 further comprising the execute cloud service locking certain ones of the stripes within the sparse file storage system.

16. The method of claim 10 further comprising the execute cloud service taking snapshots of certain ones of the stripes within the sparse file storage system.

17. A machine readable storage medium containing program code that when processed by one or more computers of an execution engine cloud service causes the one or more computers to perform a method, comprising:
receiving, at an execution engine cloud service, a request that targets a stripe within a sparse file storage system, wherein, the execution engine cloud service offers an interface to the sparse file storage system;
accessing a database cloud service to update meta data for the stripe's file within the sparse file storage system, wherein, the database cloud service keeps meta data for the sparse file storage system;
accessing an object storage cloud service to access the stripe's content, wherein, the object storage cloud service keeps respective content of stripes that are stored within the sparse file storage system; and,
caching frequently accessed content of the sparse file storage system within the execution engine cloud service.

18. The machine readable storage medium of claim 17 wherein the method further comprises:
receiving the request from the Internet;
accessing the database cloud service by sending a second request to the database cloud service through the Internet; and,
accessing the object storage cloud service by sending a third request to the object storage cloud service through the Internet.

19. The machine readable storage medium of claim 17 wherein the method further comprises mapping a filepath specified in the request to an object ID for the stripe that uniquely identifies the stripe's content within the object storage cloud service.

20. The machine readable storage medium of claim 17 further comprising offering a number of different storage system interfaces to users of the compute engine cloud service.
